(19) United States
(12) Patent Application Publication
(10) Pub. No.: US 2015/0032618 A1
(43) Pub. Date: Jan. 29, 2015

(54) Anti-fraud system and its method for on-line transaction with credit card

(71) Applicant: Yi Hung Lin, Taipei City (TW)

(72) Inventor: Yi Hung Lin, Taipei City (TW)

(21) Appl. No.: 13/949,224

(22) Filed: Jul. 23, 2013

(51) Int. Cl. G06Q 20/40; G06Q 20/24; G06Q 20/32

(52) U.S. Cl. CPC G06Q 20/4016; G06Q 20/3229; G06Q 20/24
USPC 705/44

(57) ABSTRACT

An anti-fraud system and its method for on-line transaction with credit card, comprising an on-line transaction anti-fraud system linked between at least an e-commerce client and at least a verification/authorization agency; said on-line transaction anti-fraud system and verification/authorization agency may implement corresponding verification or verification and authorization according to different trading levels of the credit card; said on-line transaction anti-fraud system consists of at least a multi-information verification module, at least a mobile phone real-time ID verification module, at least a database and at least a consumption behavior analysis module; said consumption behavior analysis module is used to analyze the historic consumption records of the credit card consumer in the database, judge the trading risk levels, and activate the multi-information verification module or the mobile phone real-time ID verification module specific to different verification mechanisms, so as to identify the risk of credit card on-line transaction.

### BACKGROUND OF INVENTION

1. Field of the Invention

The present invention relates generally to an anti-fraud system and its method for on-line transaction with credit card, and more particularly to an innovative system and its method which enable risk identification to mitigate the risk cost of Internet traders and guarantee smooth on-line trading of credit card holders by simple processes.

2. Description of Related Art

Existing “verification services” for the credit cards are implemented by the Internet shopping safety mechanism established by VISA, MasterCard and JCB, helping to identify the ID of credit card holders and improve the on-line trading safety. The card holders are required to log onto the dedicated web site of the issuing banks for safety verification, while some banks also allow for immediate registration functions at Internet shopping centers. Despite of the safety design aimed to reduce the transaction disputes and embezzlement behavior arising from use of credit cards, the card holders have opted to do nothing but abandon their trading due to failure of filing an application or forgetting their passwords, in such case the business performance will be greatly affected. Moreover, there exists a big risk for such verification since many receiving or issuing banks have not joined in this mechanism.

According to existing Internet shopping safety mechanism verified by VISA, MasterCard SecureCode, JCB J/Secure, fully-digital trading verification blocks off the transaction of customers who are unable to perform real-time password verification. If 3D verification is not implemented, the receiving banks often regulate the limit and monthly restrictions of single credit card, affecting indirectly the desire of the card holders. Also, some receiving banks cannot control efficiently the transaction of forged credit cards or the client may terminate the transaction at its own discretion, affecting seriously normal operation in this sector. Such transaction is open to dozens of issuing banks without 3D verification mechanism, so there is a growing amount of forged credit cards, and the Internet customers have to bear higher risk cost.

Additionally, prevailing 3D verification dynamic password mode also adopts fully-digital trading verification, so the issuing banks have to bear higher short message cost or manufacturing cost of Display Cards, and only a few banks are entitled to conduct this business.

Hence, there is still a room for improvement of existing credit card's “verification services”.

### SUMMARY OF THE INVENTION

The primary objective of the present invention is to provide an anti-fraud system and its method for on-line transaction with credit card, which could reduce the transactions with forged cards, eliminate the burden of card holders in remembering 3D verification passwords, thus helping to identify easily on-line transactions with credit card and alleviate the risk of Internet customers.

The anti-fraud system of the present invention for on-line transaction with credit card comprises: an on-line transaction anti-fraud system, which is linked between at least an e-commerce client and at least a verification/authorization agency; the on-line transaction anti-fraud system and the verification/authorization agency may conduct corresponding verification or corresponding verification and authorization depending on different trading risk levels; such on-line transaction anti-fraud system consists of at least a multi-information verification module, at least a mobile phone real-time ID verification module and at least a consumption behavior analysis module.

Of which, the e-commerce client covers e-commerce specific to the credit card consumers and special online stores, enabling on-line consumption by the credit card consumers. The verification/authorization agency may consist of an acquirer, an authorized clearance system and an issuing bank, which are permitted for verification or verification and authorization of credit card transactions with the on-line transaction anti-fraud system; the acquirer includes but not limited to the banks, third-party payers or cash flow companies. The consumption behavior analysis module is used to analyze the consumption data of credit card consumers, and judge the trading risk levels so as to activate different verification procedures; the consumption behavior analysis module allows to read the amount deducted from credit card of the consumer input by the e-commerce client, and compare it with a group of preset low-risk absolute settings and high-risk absolute settings, then selectively activate the corresponding multi-information verification module or the mobile phone real-time ID verification module. The multi-information verification module could utilize multi-information to establish an verification mechanism along with the verification/authorization agency, permitting to identify forged cards in medium-/high-risk transactions; of which, the multi-information contains a credit card number and a mobile phone number of the credit card consumer; the mobile phone number refers to SIM card number recorded by the verification/authorization agency correspondingly to the credit card number; the multi-information verification module could read the multi-information input by the e-commerce client containing the consumer's credit card number and mobile phone SIM card number, and the verification/authorization agency could verify the multi-information. The mobile phone real-time ID verification module permits to identify forged cards in high-risk transactions using real-time dynamic password technology based on verification mobile phone (namely, multi-information mobile phone number verified by the verification/authorization agency); the password is real-time (to be finished within a time limit) and disposable (becoming invalid upon completion); the verification/authorization agency transmits the information (including but not limited to short messages) to the verification mobile phone of the credit card consumer by real-time telecom software; the mobile phone real-time ID verification module could read the password of the verification mobile phone that's input and already sent to the credit card consumer by the e-commerce client, and the verification/authorization agency could verify such password.

Preferably, the on-line transaction anti-fraud system also consists of at least a database, which is used to store the logon data and historic consumption data of the members; the consumption behavior analysis module could also read the historic consumption data of the credit card consumer in the database, of which the historic consumption data contains the inertia average, the limit of inertia average and inertia trading period; the amount deducted from credit card is compared with a group of inertia average and the limits of inertia average, whilst the trading time corresponding to the amount deducted from credit card is compared with the inertia trading period, so as to selectively activate the corresponding multi-information verification module, or the mobile phone real-time ID verification module, enabling to implement different verification mechanisms according to the trading risk levels; of which, the inertia average refers to the average consumption value of the credit card consumer; the historic consumption data further contains cumulative credit value, which is set according to the accumulated credit of the credit card consumer; the limit of the inertia average is set according to the cumulative credit value and the inertia average (e.g.: but not limited to: limit of inertia average=inertia average*150%, of which “150%” is adjusted according to the cumulative credit value of the credit card consumer); the inertia trading period is set according to the conventional time interval of previous credit card consumption by the credit card consumer (.g.: but not limited to: time interval in the morning, afternoon or night, during holidays or non-holidays, during working hours or non-working hours or their combinations). The multi-information further contains at least the name or ID of the credit card consumer.

### BRIEF DESCRIPTION OF THE DRAWINGS

FIG. 1: a block chart of the preferred embodiment of the present invention.

FIG. 2: a structural view of the preferred embodiment of the present invention.

FIG. 3: a flow process chart of the preferred embodiment of the present invention.

FIG. 4: a flow process chart of medium-risk verification in the preferred embodiment of the present invention.

FIG. 5: a flow process chart of high-risk verification in the preferred embodiment of the present invention.

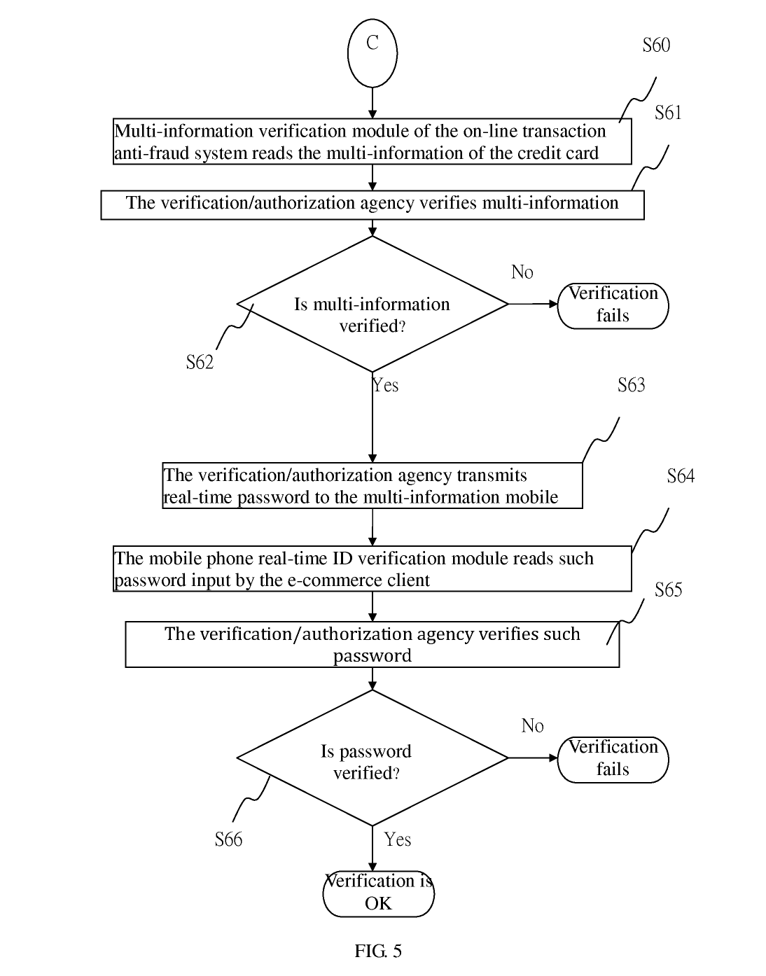

FIG. 6: a flow process chart of authorization in the preferred embodiment of the present invention.

### DETAILED DESCRIPTION OF THE INVENTION

The preferred embodiment of the present invention is described in detail with reference to the following accompanying drawings.

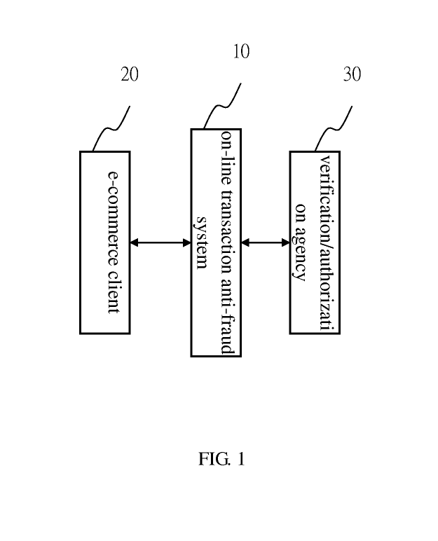

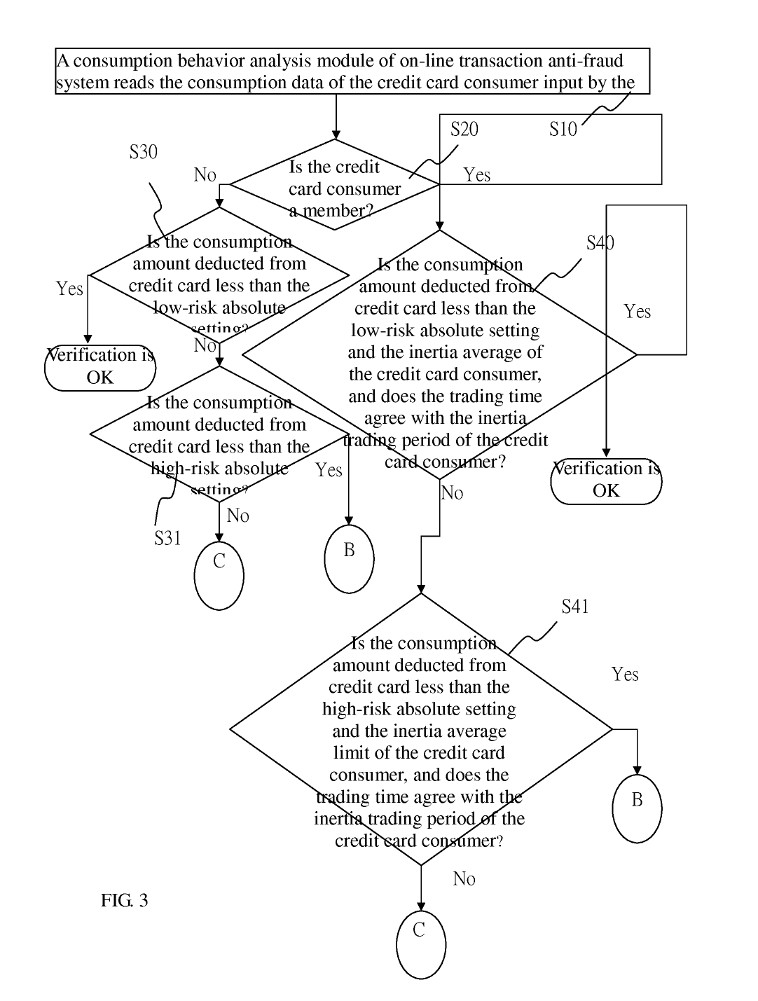

Referring to FIGS. 1˜2—a block chart and a structural view of the preferred embodiment of the present invention, FIGS. 3˜6—flow process charts of the preferred embodiment of the present invention or the medium-/high-risk verification and authorization in the preferred embodiment of the present invention, said system comprises an on-line transaction anti-fraud system 10.

Referring to FIG. 1, said on-line transaction anti-fraud system 10 is linked between at least an e-commerce client 20 and at least a verification/authorization agency 30; said on-line transaction anti-fraud system 10 and verification/authorization agency 30 may conduct corresponding verification or corresponding verification and authorization depending on different trading risk levels of the credit card.

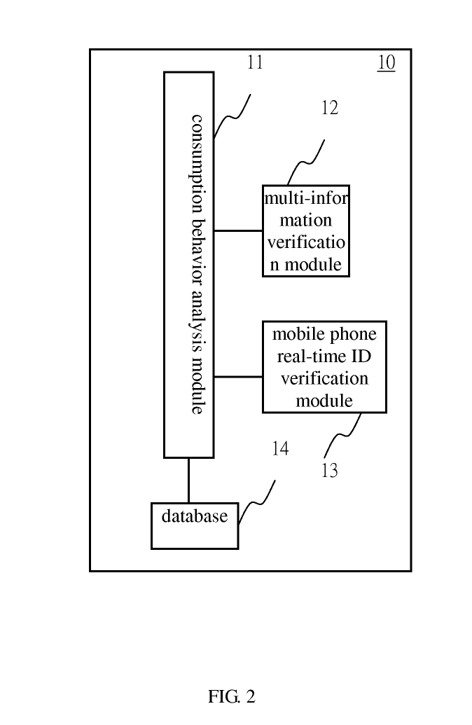

Referring to FIG. 2, said on-line transaction anti-fraud system 10 further consist of a consumption behavior analysis module 11, a multi-information verification module 12, a mobile phone real-time ID verification module 13 and a database 14. The database 14 is used to store the logon data and historic consumption data of the members; of which the historic consumption data contains the inertia average, the limit of inertia average and inertia trading period. The multi-information verification module 12 could read the multi-information input by the e-commerce client 20 containing the consumer's credit card number and mobile phone SIM card number, and the verification/authorization agency 30 could verify the multi-information. The mobile phone real-time ID verification module 13 could read the password of the mobile phone SIM card number input and sent by the e-commerce client 20 to the credit card consumer, and the verification/authorization agency 30 could verify such password. The consumption behavior analysis module 11 could read the amount deducted from credit card and trading time of the credit card consumer input by the e-commerce client 20, and compare the amount deducted from credit card with a group of preset low-risk absolute settings and high-risk absolute settings. It also reads the historic consumption data of the credit card consumer in the database 14, and compares the amount deducted from credit card with a group of inertia average and the limits of inertia average, whilst the trading time is compared with the inertia trading period, so as to selectively activate the corresponding multi-information verification module 12, or the mobile phone real-time ID verification module 13, enabling to implement different verification mechanisms according to the trading risk levels.

Referring to FIG. 3, said on-line transaction anti-fraud system 10 implements the verification by the following steps: firstly in Step S10, the consumption behavior analysis module 11 of the on-line transaction anti-fraud system 10 reads the amount deducted from credit card and trading time of the credit card consumer input by the e-commerce client 20, and compares the amount deducted from credit card with a group of preset low-risk absolute settings (e.g.: not limited to NT$1000) and high-risk absolute settings (e.g.: not limited to NT$5000); it also reads the historic consumption data of the credit card consumer in the database 14, and compares the amount deducted from credit card with a group of inertia average and the limits of inertia average, and also compares the trading time with an inertia trading period. According to aforementioned results, the on-line transaction anti-fraud system 10 and the verification/authorization agency 30 implement the trading verification specific to the credit card risk levels.

The trading verification specific to the credit card risk levels includes the following steps:

Firstly, the consumption behavior analysis module 11 judges if the credit card consumer of the e-commerce client 20 is a registered member, as shown in Step S20.

If the credit card consumer is not a member, the consumption behavior analysis module 11 will then judge if the consumption amount deducted from credit card is less than the low-risk absolute setting, as shown in Step S 30; if the consumption amount deducted from credit card (e.g.: not limited to NT$500) is less than the low-risk absolute setting, the verification is successfully completed such that the credit card's trading cost could be reduced in low-risk transactions without need of verification mechanism; otherwise, the consumption behavior analysis module 11 judges if the consumption amount deducted from credit card is less than the high-risk absolute setting, as shown in Step S31; if the consumption amount deducted from credit card (e.g.: not limited to NT$2500) is less than the high-risk absolute setting, users may implement medium-risk verification, otherwise high-risk verification.

If the credit card consumer is a member, the consumption behavior analysis module 11 then judges if the consumption amount deducted from credit card is less than the low-risk absolute setting and the inertia average of the credit card consumer (e.g.: not limited to NT$2000), and the trading time agrees with the inertia trading period of the credit card consumer, as shown in Step S40, if the consumption amount deducted from credit card (e.g.: not limited to NT$500) is less than the low-risk absolute setting and the inertia average of the credit card consumer, and the trading time agrees with the inertia trading period of the credit card consumer, the verification is successfully completed such that the credit card's trading cost could be reduced in low-risk transactions without need of verification mechanism; otherwise, the consumption behavior analysis module 11 judges if the consumption amount deducted from credit card is less than the high-risk absolute setting and the inertia average limit of the credit card consumer, and the trading time agrees with the inertia trading period of the credit card consumer, as shown in Step S41, if the consumption amount deducted from credit card (e.g.: not limited to NT$2500) is less than the high-risk absolute setting and the inertia average limit of the credit card consumer (e.g.: not limited to NT$ 3000=NT$2000*150%), and the trading time agrees with the inertia trading period of the credit card consumer, users may implement medium-risk verification, otherwise high-risk verification.

The medium-risk verification includes the following steps:

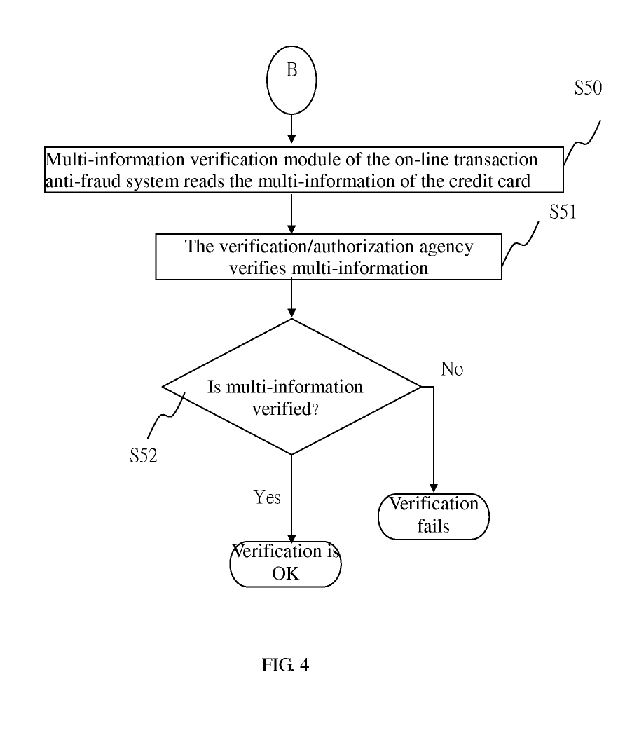

Firstly, multi-information verification module 12 of the on-line transaction anti-fraud system 10 reads the multi-information of the credit card number and mobile phone SIM card number of the credit card consumer input by the e-commerce client 20, as shown in Step S50, and the verification/authorization agency 30 verifies multi-information according to the stored credit card number and corresponding mobile phone SIM card number, as shown in Step S51; next, multi-information verification module 12 of the on-line transaction anti-fraud system 10 judges if the multi-information has been verified by the verification/authorization agency 30, as shown in Step S52, if the multi-information is successfully verified, the verification process is successfully completed, otherwise verification has failed and must be stopped, as shown in FIG. 4, helping to realize lower verification cost during medium-risk transactions.

The high-risk verification includes the following steps:

Firstly, multi-information verification module 12 of the on-line transaction anti-fraud system 10 reads the multi-information of the credit card number and mobile phone SIM card number of the credit card consumer input by the e-commerce client 20, as shown in Step S60, and the verification/authorization agency 30 verifies multi-information according to the stored credit card number and corresponding mobile phone SIM card number, as shown in Step S61; next, multi-information verification module 12 of the on-line transaction anti-fraud system 10 judges if the multi-information has been verified by the verification/authorization agency 30, as shown in Step S62, if the multi-information is not successfully verified, the verification has failed and must be stopped, otherwise users may implement Step S63.

In Step S63, the multi-information mobile phone number verified by the verification/authorization agency 30 refers to a verification mobile phone; the verification/authorization agency 30 transmits the password (including but not limited to short messages) to the verification mobile phone of the credit card consumer by real-time telecom software; then users may implement Step S64.

In Step S64, mobile phone real-time ID verification module 13 of the on-line transaction anti-fraud system 10 reads the password input by the e-commerce client 20, and the verification/authorization agency 30 verifies such password, as shown in Step S65; next, mobile phone real-time ID verification module 13 of the on-line transaction anti-fraud system 10 judges if the password is successfully verified by the verification/authorization agency 30, as shown in Step S66, if the password is successfully verified, the verification is successfully completed, otherwise the verification has failed and must be stopped, helping to identify forged cards with costly verification mechanism only during high-risk transactions.

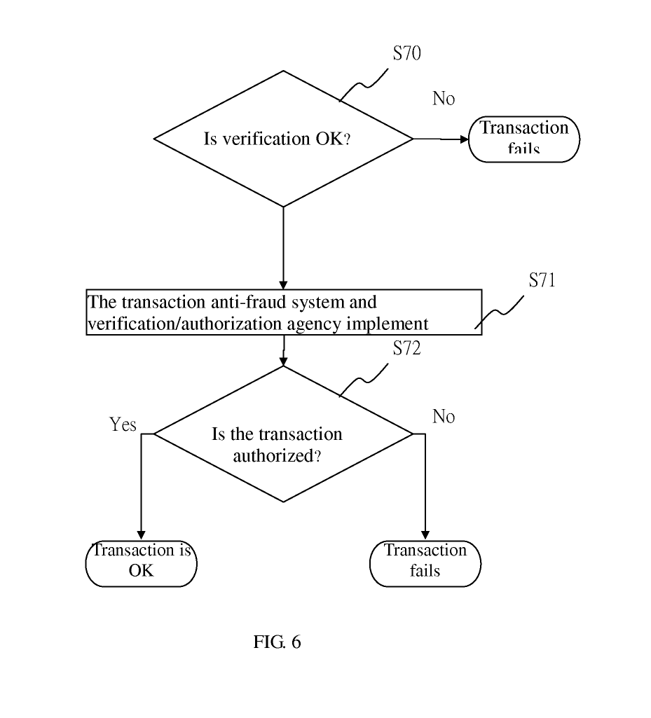

In FIG. 6, the on-line transaction anti-fraud system 10 and the verification/authorization agency 30 could further incorporate an authorization mechanism. Firstly, the on-line transaction anti-fraud system 10 judges if the verification is OK, as shown in Step S70, in case of failure of verification, the transaction of credit card has failed and must be stopped; otherwise users may implement authorization of conventional credit card transaction, as shown in Step S71; next, the on-line transaction anti-fraud system 10 judges if the transaction authorization is successfully completed, as shown in Step S72, if transaction authorization is successfully made, the credit card transaction is successful, otherwise the credit card transaction has failed and must be stopped.

Although the invention has been explained in relation to its preferred embodiment, it is to be understood that many other possible modifications and variations can be made without departing from the spirit and scope of the invention as hereinafter claimed.

1. An anti-fraud system for on-line transaction with credit card, which comprising: an on-line transaction anti-fraud system, which is linked between at least an e-commerce client and at least a verification/authorization agency; the on-line transaction anti-fraud system and the verification/authorization agency may selectively conduct corresponding verification or corresponding verification and authorization depending on different trading risk levels of the credit card; said on-line transaction anti-fraud system consists of:
at least a multi-information verification module, which could read the multi-information of the credit card consumer input by the e-commerce client, and transmit to the verification/authorization agency for verification; of which the multi-information at least contains a credit card number and a mobile phone SIM card number;
at least a mobile phone real-time ID verification module, which could read the password of the mobile phone SIM card number that's input and already sent by the e-commerce client, and the verification/authorization agency could verify such password;
at least a consumption behavior analysis module, which could read the amount deducted from credit card of the credit card consumer input by the e-commerce client, and compare it with a group of preset low-risk absolute setting and high-risk absolute setting, so as to selectively activate corresponding multi-information verification module or mobile phone real-time ID verification module to implement the trading verification of the credit card.

2. The anti-fraud system for on-line transaction with credit card as claimed in claim 1, wherein said on-line transaction anti-fraud system further includes at least a database, which is used to store the logon data and historic consumption data of the members; of which the historic consumption data contains the inertia average, the limit of inertia average and inertia trading period; the consumption behavior analysis module reads the trading time corresponding to the amount deducted from credit card, and further reads the historic consumption data of the credit card consumer in the database; meanwhile the amount deducted from credit card is compared with a group of inertia average and limit of inertia average, and the trading time is compared with the inertia trading period.

3. The anti-fraud system for on-line transaction with credit card as claimed in claim 2, wherein said historic consumption data contains cumulative credit value, which is used to adjust the limit of the inertia average.

4. The anti-fraud system for on-line transaction with credit card as claimed in claim 1, wherein said multi-information further contains at least the name or ID of the credit card consumer.

5. The anti-fraud system for on-line transaction with credit card as claimed in claim 2, wherein said multi-information further contains at least the name or ID of the credit card consumer.

6. The anti-fraud system for on-line transaction with credit card as claimed in claim 3, wherein said multi-information further contains at least the name or ID of the credit card consumer.

7. An anti-fraud method for on-line transaction with credit card, which is applied to an on-line transaction anti-fraud system; said on-line transaction anti-fraud system comprises at least a consumption behavior analysis module, at least a multi-information verification module and at least a mobile phone real-time ID verification module; this system is linked between at least an e-commerce client and at least a verification/authorization agency; such method contains the following steps:
(a) the consumption behavior analysis module reads amount deducted from credit card of the credit card consumer input by the e-commerce client, and compares it with a group of preset low-risk absolute setting and high-risk absolute setting; according to the comparison result, said on-line transaction anti-fraud system and verification/authorization agency implement the trading verification of the credit card, which contains the following steps:
(a1) if the amount deducted from credit card is less than the low-risk absolute setting, implement Step (a4); otherwise implement Step (a2);
(a2) if the amount deducted from credit card is less than the high-risk absolute setting, implement a medium-risk verification in Step (a4); otherwise implement Step (a3);
(a3) implement a high-risk verification in Step (a4); and
(a4) finish the verification.

8. The anti-fraud method for on-line transaction with credit card as claimed in claim 7, wherein Step (b) is added after completion of Step (a4); in said Step (b), said on-line transaction anti-fraud system and verification/authorization agency implement conventional trading authorization of the credit card.

9. The anti-fraud method for on-line transaction with credit card as claimed in claim 7, wherein said medium-risk verification in Step (a2) contains the following steps:
(c1) the multi-information verification module reads multi-information of the credit card consumer input by the e-commerce client; of which the multi-information contains at least a credit card number and a mobile phone SIM card number;
(c2) the verification/authorization agency verifies the multi-information; and
(c3) if the multi-information is successfully verified by the verification/authorization agency, the verification is OK; otherwise the verification has failed.

10. The anti-fraud method for on-line transaction with credit card as claimed in claim 8, wherein said medium-risk verification in Step (a2) contains the following steps:
(c1) the multi-information verification module reads multi-information of the credit card consumer input by the e-commerce client; of which the multi-information contains at least a credit card number and a mobile phone SIM card number;
(c2) the verification/authorization agency verifies the multi-information; and
(c3) if the multi-information is successfully verified by the verification/authorization agency, the verification is OK; otherwise the verification has failed.

11. The anti-fraud method for on-line transaction with credit card as claimed in claim 9, wherein said multi-information in Step (c1) further contains at least the name or ID.

12. The anti-fraud method for on-line transaction with credit card as claimed in claim 7, wherein said high-risk verification in Step (a3) contains the following steps:
(d1) the multi-information verification module reads multi-information of the credit card consumer input by the e-commerce client; of which said multi-information at least contains a credit card number and a mobile phone SIM card number;
(d2) the verification/authorization agency verifies the multi-information;
(d3) if the multi-information is verified successfully by the verification/authorization agency, implement Step (d4); otherwise the verification has failed, and users may implement Step (d8);
(d4) the verification/authorization agency transmits real-time password to the multi-information mobile phone SIM card number of the credit card consumer;
(d5) the mobile phone real-time ID verification module reads such password input by the e-commerce client;
(d6) the verification/authorization agency verifies such password;
(d7) if the password is verified successfully by the verification/authorization agency, the verification is OK; otherwise the verification has failed; and
(d8) finish the verification.

13. The anti-fraud method for on-line transaction with credit card as claimed in claim 8, wherein said high-risk verification in Step (a3) contains the following steps:
(d1) the multi-information verification module reads multi-information of the credit card consumer input by the e-commerce client; of which said multi-information at least contains a credit card number and a mobile phone SIM card number;
(d2) the verification/authorization agency verifies the multi-information;
(d3) if the multi-information is verified successfully by the verification/authorization agency, implement Step (d4); otherwise the verification has failed, and users may implement Step (d8);
(d4) the verification/authorization agency transmits real-time password to the multi-information mobile phone SIM card number of the credit card consumer;
(d5) the mobile phone real-time ID verification module reads such password input by the e-commerce client;
(d6) the verification/authorization agency verifies such password;
(d7) if the password is verified successfully by the verification/authorization agency, the verification is OK; otherwise the verification has failed; and
(d8) finish the verification.

14. An anti-fraud method for on-line transaction with credit card, which is applied to an on-line transaction anti-fraud system; said on-line transaction anti-fraud system comprises at least a consumption behavior analysis module, at least a multi-information verification module and at least a mobile phone real-time ID verification module; this system is linked between at least an e-commerce client and at least a verification/authorization agency; such method contains the following steps:
(a) the consumption behavior analysis module reads amount deducted from credit card and trading time of the credit card consumer input by the e-commerce client, and compares it with a group of preset low-risk absolute setting and high-risk absolute setting; it also reads historic consumption data of the credit card consumer in a database; of which the historic consumption data contains inertia average, limit of inertia average and inertia trading period; the amount deducted from credit card is compared with a group of inertia average and the limit of inertia average, and the trading time is compared with the inertia trading period; said on-line transaction anti-fraud system and verification/authorization agency implement the trading verification of the credit card according to the historic consumption data; the trading verification of the credit card contains the following steps:
(a1) if the amount deducted from credit card is less than the low-risk absolute setting and the inertia average, and the trading time agrees with the credit card consumer's inertia trading period, implement Step (a4); otherwise implement Step (a2);
(a2) if the amount deducted from credit card is less than the high-risk absolute setting and the limit of the inertia average, and the trading time agrees with the credit card consumer's inertia trading period, implement a medium-risk verification in Step (a4); otherwise implement Step (a3);
(a3) implement a high-risk verification in Step (a4); and
(a4) finish the verification.

15. The anti-fraud method for on-line transaction with credit card as claimed in claim 14, wherein Step (b) is added after completion of Step (a4); in said Step (b), said on-line transaction anti-fraud system and verification/authorization agency implement conventional trading authorization of the credit card.

16. The anti-fraud method for on-line transaction with credit card as claimed in claim 14, wherein said medium-risk verification in Step (a2) contains the following steps:
(c1) the multi-information verification module reads multi-information of the credit card consumer input by the e-commerce client; of which the multi-information contains at least a credit card number and a mobile phone SIM card number;
(c2) the verification/authorization agency verifies the multi-information; and
(c3) if the multi-information is successfully verified by the verification/authorization agency, the verification is OK; otherwise the verification has failed.

17. The anti-fraud method for on-line transaction with credit card as claimed in claim 15, wherein said medium-risk verification in Step (a2) contains the following steps:
(c1) the multi-information verification module reads multi-information of the credit card consumer input by the e-commerce client; of which the multi-information contains at least a credit card number and a mobile phone SIM card number;
(c2) the verification/authorization agency verifies the multi-information; and
(c3) if the multi-information is successfully verified by the verification/authorization agency, the verification is OK; otherwise the verification has failed.

18. The anti-fraud method for on-line transaction with credit card as claimed in claim 16, wherein said multi-information in Step (c1) further contains at least the name or ID.

19. The anti-fraud method for on-line transaction with credit card as claimed in claim 14, wherein said high-risk verification in Step (a3) contains the following steps:
(d1) the multi-information verification module reads multi-information of the credit card consumer input by the e-commerce client; of which said multi-information at least contains a credit card number and a mobile phone SIM card number;
(d2) the verification/authorization agency verifies the multi-information;
(d3) if the multi-information is verified successfully by the verification/authorization agency, implement Step (d4); otherwise the verification has failed, and users may implement Step (d8);
(d4) the verification/authorization agency transmits real-time password to the multi-information mobile phone SIM card number of the credit card consumer;
(d5) the mobile phone real-time ID verification module reads such password input by the e-commerce client;
(d6) the verification/authorization agency verifies such password;
(d7) if the password is verified successfully by the verification/authorization agency, the verification is OK; otherwise the verification has failed; and
(d8) finish the verification.

20. The anti-fraud method for on-line transaction with credit card as claimed in claim 15, wherein said high-risk verification in Step (a3) contains the following steps:
(d1) the multi-information verification module reads multi-information of the credit card consumer input by the e-commerce client; of which said multi-information at least contains a credit card number and a mobile phone SIM card number;
(d2) the verification/authorization agency verifies the multi-information;
(d3) if the multi-information is verified successfully by the verification/authorization agency, implement Step (d4); otherwise the verification has failed, and users may implement Step (d8);
(d4) the verification/authorization agency transmits real-time password to the multi-information mobile phone SIM card number of the credit card consumer;
(d5) the mobile phone real-time ID verification module reads such password input by the e-commerce client;
(d6) the verification/authorization agency verifies such password;
(d7) if the password is verified successfully by the verification/authorization agency, the verification is OK; otherwise the verification has failed; and
(d8) finish the verification.
